(19) United States
(12) Patent Application Publication
(10) Pub. No.: US 2008/0098657 A1
(43) Pub. Date: May 1, 2008

(54) Mid-Travel Position Installation of Window Glass

(75) Inventors: James O. Campbell, Sterling Heights, MI (US); David Gunthner, Clinton Township, MI (US)

Correspondence Address: KAPLAN GILMAN GIBSON & DERNIER L.L.P., 900 ROUTE 9 NORTH, WOODBRIDGE, NJ, 07095, US

(73) Assignee: Faurecia Interior Systems U.S.A., Inc., Auburn Hills, MI (US)

(21) Appl. No.: 11/553,155

(22) Filed: Oct. 26, 2006

(51) Int. Cl. E05F 11/38

(52) U.S. Cl. 49/375

(57) ABSTRACT

Methods, assemblies and apparatus related to a mid-travel glass load of full drop glass into a lift plate involve use of a support pin traversing a carrier plate to immobilize the lift plate at a mid-travel position. When the lift plate is properly aligned at the mid-travel position, pin extensions of the support pin extend through holes in the carrier plate and lodge in wells in the lift plate. Removal of the pin extensions from the wells mobilizes the lift plate again. One or more embodiments may include various molded features on the carrier plate to stabilize, support and guide the support pin.

### BACKGROUND

1. Field of Invention

The present invention relates to methods, assemblies, and apparatus relating to installation of automobile door window glass in rail-less window regulator door modules, and in particular, to installation of window glass at a mid-travel position.

2. Description of Related Art

Automobiles typically include at least two doors having door windows that open in that the window glass ascends and descends. Door windows, in which the ascent and descent of the window glass is electronically activated, are commonly known as power windows. Windows that are not power windows typically are wound and unwound manually by the vehicle occupant to cause the window glass to ascend and descend. The ascent and descent of the window glass often is realized by a winch mechanism attached to window glass. This winch mechanism may be referred to a rail-less window regulator door module. Many door windows are capable of opening completely such that the window glass descends entirely into the car door, known as “full drop,” leaving only the top edge of the window glass visible in the window slot into which the window glass is retracted.

Installation of automobile door window glass is known as “glass load,” insofar as the glass is loaded into the door module through the window slot and must engage the lift plate of the regulator door module. Glass load of full drop glass can be challenging because the lift plate historically is in the fully lowered position to provide adequate resistance against which to push the glass into the module until the glass is inserted fully. Currently, the line operator must drop the glass into the door with enough force to seat the glass into the lift plate, plus ensure a correct seating has taken place. This is often a blind operation in that the line operator cannot see or access the engagement of the window glass into the lift plate. Further, with the lift plate fully lowered, there is no surface area of the glass to hold during the loading of the glass to lift plate, making proper insertion problematic. If the glass is not seated properly, the operator must try to remove the glass from the door with his/her fingertips to begin the install procedure again.

The challenge is to position the lift plate such that there will be glass in the operator's hand during the installation of glass into lift plate. Thus, it is necessary to develop new products and methods that overcome the above-mentioned challenges of the prior art and allow insertion of the glass into the lift plate when the lift plate is at a mid-point.

### SUMMARY OF THE INVENTION

In accordance with one or more embodiments of the present invention, methods, assemblies and apparatus related to a mid-travel glass load of full drop glass involve use of a support pin traversing a carrier plate to immobilize a lift plate at a mid-travel position.

According to one or more embodiments of the present invention, a method of loading automobile window glass may include aligning a lift plate at a mid-travel position; supporting a pin extension by a carrier plate; immobilizing the lift plate at the mid-travel position by engaging the pin extension with the lift plate; loading the window glass into the lift plate; and mobilizing the lift plate by disengaging the pin extension from the lift plate.

In various embodiments of the present invention, engaging the pin extension may comprise inserting the pin extension into a pin holding well of the lift plate; and disengaging the pin extension may comprise removing the pin extension from the pin holding well.

Also in various embodiments of the present invention, the pin extension may comprise a support pin; inserting the pin extension may comprise inserting the support pin through pin holes in a carrier plate; and removing the pin extension may comprise removing the support pin from the pin holes.

According to one or more embodiments of the present invention, an apparatus for supporting a lift plate at a mid-travel position for loading of automobile window glass within a door may include a carrier plate having at least one pin guide hole operable to allow a pin extension to traverse the carrier plate to engage the lift plate for immobilization of the lift plate at the mid-travel position. Furthermore, the carrier plate may include at least one support feature operable to support a support pin having at least one pin extension.

According to one or more embodiments of the present invention, an apparatus for lifting automobile window glass within a door may include a lift plate having at least one pin holding well operable to engage a pin extension for immobilization of the lift plate at a mid-travel position.

According to one or more embodiments of the present invention, an assembly for supporting a lift plate at a mid-travel position for loading of automobile window glass within a door may include a pin extension operable to withstand a force of the loading of the glass within the door; a lift plate having at least one pin holding well operable to engage the pin extension; and a carrier plate operable to engage and disengage the pin extension to allow the pin extension to engage and disengage, respectively, the lift plate at the mid-travel position for immobilization and mobilization, respectively, of the lift plate at the mid-travel position.

The advantages of this invention are best understood after reading the detailed technical description, and in relation to existing glass load of full drop automobile window glass. Nonetheless, some of the advantages are highlighted below.

Among other advantages, the present invention facilitates a mid-travel glass load allowing an operator to seat the glass into a lift plate with a portion of glass above the beltline of door. This provides the operator the ability to maneuver the glass into the lift plate without the use of specialized tools. If the operator is unable to initially seat the glass, the operator is able to maintain a hold on the glass for subsequent load attempts.

Others have sought to improve the interaction of the glass with a lift plate. For instance, in another patent application to Faurecia Innenraum Systeme GmbH, published as DE 10 2004 017 645 A1, lower-end blocks are disclosed that engage a lift plate at a bottom-travel position of the lift plate relative to, and within, the door panel. The lower end blocks provide a stable support to the lift plate, although a significant portion of the window glass remains inaccessible within the door panel as the window glass is lowered into engagement with the lift plate. After the window engages the lift plate at the bottom-travel position, the lift plate and window glass are permitted to travel the entire distance within the door panel. This loading solution, however, loads the glass at the bottom-travel position and leaves the blocks inside the door panel, as the blocks are an integral part of the door panel.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the issued claims. The drawings may not be to scale, and the aspects of the drawings may not be to scale relative to each other.

FIG. 1 is a perspective view illustrating an exemplary support assembly for mid-travel position glass load in accordance with one or more embodiments of the present invention.

FIG. 2 is a perspective view illustrating a first side of an exemplary carrier plate in accordance with one or more embodiments of the present invention.

FIG. 3 is a perspective view illustrating a second side of an exemplary carrier plate in accordance with one or more embodiments of the present invention.

FIG. 4 is a flow diagram illustrating further exemplary process actions that may be carried out to load window glass in accordance with one or more embodiments of the present invention.

### DETAILED DESCRIPTION OF THE PRESENT INVENTION

The present invention relates to methods, assemblies and apparatus related to a mid-travel glass load of full drop glass.

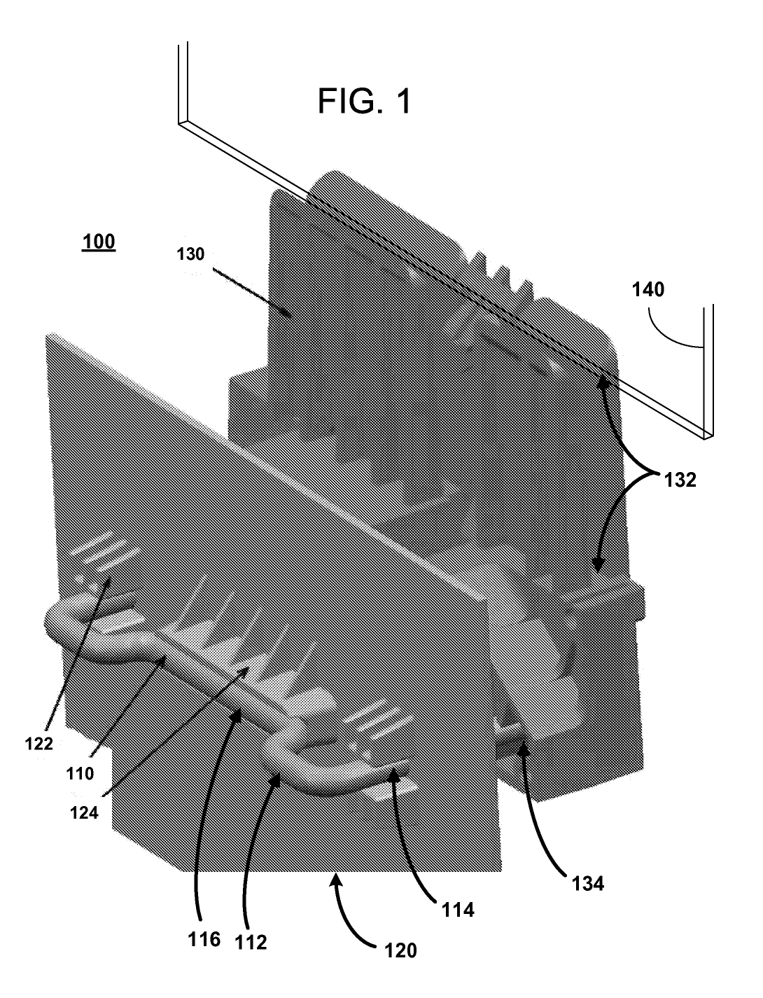

Referring to FIG. 1, a perspective view illustrates an exemplary support assembly 100 for mid-travel position glass load in accordance with one or more embodiments of the present invention. Support assembly 100 may include a support pin 110, a carrier plate 120 and a lift plate 130. Support pin 110 fixes the lift plate 130 at the mid-travel position for easier installation of window glass 140. It is noted that the mid-travel position does not require a position that is exactly at a midpoint between upper and lower extremities of the travel positions of the lift plate 130; indeed, the mid-travel position may be anywhere between such extreme positions. Support features 122 and 124 provide support and location to the support pin 110. After installation of the glass 140 to the lift plate 130 in slot 132, the support pin 110 will be removed from the support assembly 100, such as by placing fingers into gaps formed by bends 112 and features 122 and 124 and pulling, and stored for reuse. The lift plate 130 may have built-in features, such as pin holding wells 134, to accept the support pin 110. The pin holding wells 134 may be designed not to allow pin extensions 114 to pass through the lift plate 130. Naturally, a pin extension 114 needs to be strong enough to withstand, without being lastingly bent or deformed, the force of loading the glass 140 within the door. As shown in FIG. 1, support pin 110 may include two pin extensions 114 connected by a connection rod 116 that may include bends 112.

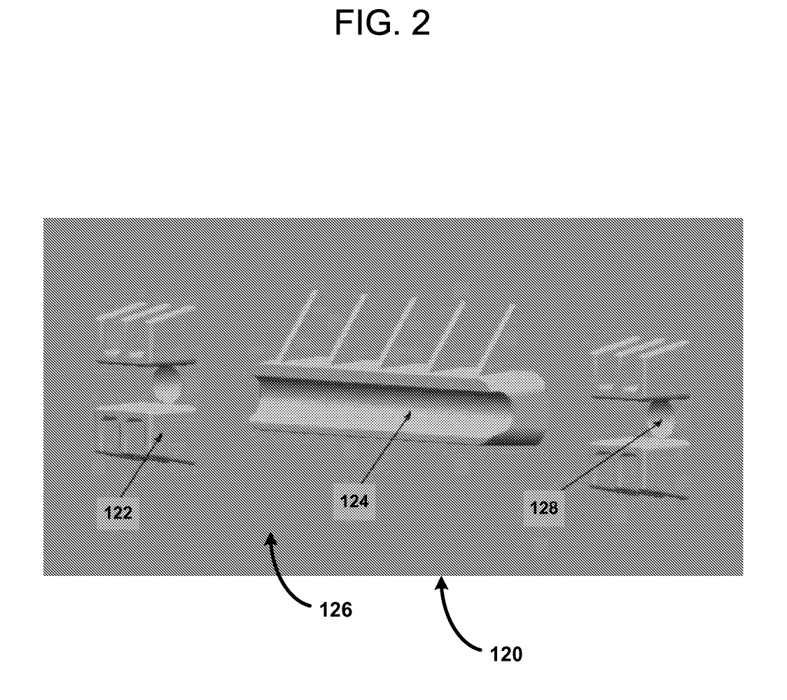

Referring to FIG. 2, a perspective view illustrates a first side 126 of an exemplary carrier plate 120 in accordance with one or more embodiments of the present invention. First side 126 may be known in the industry as the dry side of the door panel. The support features 122 and 124 are designed for the dry side 126 of carrier plate 120 to properly position the support pin 110. Feature 122 provides for vertical reinforcement of support pin 110 during the loading of glass 140 into the slot 132 of lift plate 130. Feature 124 provides depth (cross car or inboard/outboard) positioning of support pin 110. Placement of features 122 and 124 on carrier plate 120 provide the proper location of lift plate 130 to glass load at a mid-travel position with respect to the door. Pin guide holes 128 support the pin 110, guide the pin extensions 114 to lift plate 130, and allow the pin extensions 114 to traverse the carrier plate 120. Pin guide holes 128 typically would will be sealed or plugged after load of glass 140 to the lift plate 130.

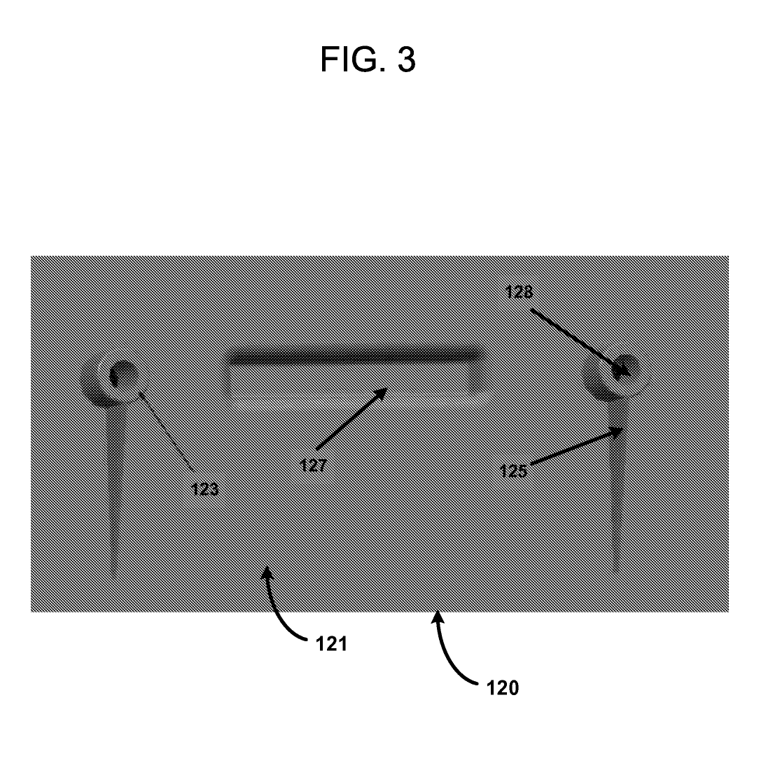

Referring to FIG. 3, a perspective view illustrates a second side 121 of the carrier plate 120 in accordance with one or more embodiments of the present invention. Second side 121 may be known in the industry as the wet side of the door panel. Additional support features 123 include the support towers 123 for the support pin 110 on the wet side 121 of the carrier plate 120. Additional ribbing 125 may be incorporated as required to withstand the glass installation load transmitted through the support pin 110 to the carrier plate 130. Indenture 127 also may be embossed in carrier plate 120 when forming feature 124 as added structure support.

Although depicted as having two holes 128 and two wells 134, the assembly 100 may include as few as one hole 128 and one well 134. Alternatively, the assembly 100 may include more than two holes 128 and more than two wells 134. The assembly 100 likewise may include more than one support pin 110. Moreover, each support pin 110 may have one pin extension 114, two pin extensions 114, as depicted, or more than two pin extensions 114. The support pin 110, with pin extensions 114, the carrier plate holes 128 and the lift plate wells 134 need only align at one mid-travel position, but for purposes of adaptability, various configurations of extensions 114, holes 128, and wells 134 may be present in a single assembly 100 to allow for use in different vehicles, use at different mid-travel positions, different size window glass, etc.

Engagement of the pin extensions 114 with the lift plate 130 immobilizes the lift plate 130, i.e., makes the lift plate 130 motionless and prevents the lift plate 130 from moving. To allow the lift plate 130 to travel again after the glass 140 has been inserted, the pin extensions 114 need to be disengaged from the wells 134. Disengagement of the pin extensions 114 from the lift plate 130 mobilizes the lift plate 130, i.e., makes the lift plate 130 ready for movement or action. However, according to other embodiments of the present invention, the pin extensions 114 may be retracted by telescoping, rather than needing to fully remove the support pin 110. Such an arrangement may involve integrating the support pin 110 into the carrier plate 120 so that the pin 110 is not removed, but remains with the carrier plate 120 for possible future re-use.

In still other embodiments, the pin extension 114 may comprise a hinge and spring, so that when the pin extension 114 is released to engage the lift plate 130, the lift plate 130 may displace the pin extension 114 in an upward direction, allowing the pin extension 114 to engage the well 134, so that the lift plate 130 may not travel in the downward direction. Once the glass 140 is loaded in the lift plate 130, the lift plate 130 may move upward, disengaging the pin extension 114, and the pin extension 114 may be retracted to avoid unintended interference with the lift plate 130.

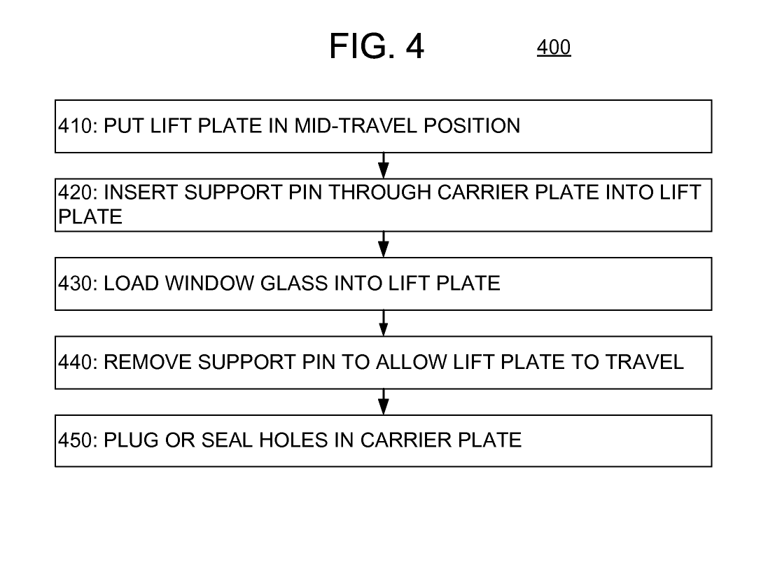

Referring to FIG. 4, a flow diagram illustrates process actions that may be carried out to load window glass 140 in process 400 in accordance with one or more embodiments of the present invention. An exemplary adjustment process 400 may include some or all of the enumerated actions. In action 410 of process 400, a lift plate 130 is positioned in the mid-travel position opposite features 122, 123, 124, 125 so that holes 128 line up with wells 134. In action 420, a support pin 110 is inserted through holes 128, with the pin extensions 114 fitting into wells 134. In action 430, window glass 140 is loaded into slot 132 of lift plate 130 until the glass 140 is firmly in place. In action 440, the support pin 110 may be removed by pulling at bends 112 until the pin extensions 114 clear the holes 128. In action 450, the holes 128 may be plugged or sealed.

As discussed above, a removable support pin engages a lift plate of a door module at a mid-travel position. The removable support pin traverses the door panel side through pin guide holes and lodges in pin holding wells located inside the door panel. When the lift plate is placed in the mid-travel position, the support pin is inserted through the pin guide holes, engages the lift plate and lodges in the pin holding wells. The support pin provides a stable support to the lift plate while a significant portion of the window glass remains accessible above the door panel as the window glass is lowered into engagement with the lift plate. After the window engages the lift plate at the mid-travel position, the support pin is removed from the door panel and disengages the lift plate, permitting the lift plate and window glass to travel the entire distance within the door panel. The embodiments of the present invention not only allow removal and reuse of the support pin, but support a mid-travel position without making the interior of the door panel more complex or heavier.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of loading automobile window glass, the method comprising:
aligning a movable lift plate at a mid-travel position with a fixed carrier plate within a door module;
immobilizing the lift plate at the mid-travel position by passing at least one pin extension through the carrier plate and engaging the pin extension with the lift plate;
loading the window glass into the lift plate; and
mobilizing the lift plate by disengaging the pin extension from the lift plate.

2. The method of claim 1, wherein:
engaging the pin extension comprises inserting the pin extension into a pin holding well of the lift plate; and
disengaging the pin extension comprises removing the pin extension from the pin holding well.

3. The method of claim 2, wherein:
the pin extension comprises a support pin;
inserting the pin extension comprises inserting the support pin through pin holes in the carrier plate; and
removing the pin extension comprises removing the support pin from the pin holes.

4. The method of claim 3, further comprising:
sealing the pin holes after removing the support pin.

5. The method of claim 3, wherein the support pin comprises two pin extensions connected by a connection rod.

6. The method of claim 5, wherein the connection rod comprises two bends, and wherein removing the pin extension comprising pulling out the support pin by the bends.

7. The method of claim 1, wherein:
supporting the pin extension by the carrier plate comprises using at least one support feature of the carrier plate to position and support the pin extension.

8. The method of claim 7, wherein the at least one support feature comprises at least one of a vertical reinforcement feature, a depth positioning feature, a guide feature, a support tower, an ribbing, and an indenture.

9. An apparatus for supporting a lift plate at a mid-travel position for loading of automobile window glass within a door, the apparatus comprising a carrier plate having at least one pin guide hole operable to allow a pin extension to traverse the carrier plate to engage the lift plate for immobilization of the lift plate at the mid-travel position.

10. The apparatus of claim 9, further comprising at least one support feature operable to support a support pin, the support pin comprising at least one pin extension.

11. The apparatus of claim 10, wherein the at least one support feature comprises at least one of a vertical reinforcement feature, a depth positioning feature, a guide feature, a support tower, an ribbing, and an indenture.

12. The apparatus of claim 10, wherein the support pin comprises two pin extensions connected by a connection rod.

13. The apparatus of claim 12, wherein the connection rod comprises two bends.

14. An assembly for supporting a lift plate at a mid-travel position for loading of automobile window glass within a door, the assembly comprising:
a pin extension operable to withstand a force of the loading of the glass within the door;
a lift plate having at least one pin holding well operable to engage the pin extension; and
a carrier plate operable to engage and disengage the pin extension to allow the pin extension to engage and disengage, respectively, the lift plate at the mid-travel position for immobilization and mobilization, respectively, of the lift plate at the mid-travel position.

15. The assembly of claim 14, wherein the carrier plate further comprises at least one pin guide hole operable to allow a pin extension to traverse the carrier plate to engage the lift plate.

16. The assembly of claim 14, wherein the carrier plate further comprises at least one support feature operable to support a support pin, the support pin comprising at least one pin extension.

17. The apparatus of claim 16, wherein the at least one support feature comprises at least one of a vertical reinforcement feature, a depth positioning feature, a guide feature, a support tower, an ribbing, and an indenture.

18. The assembly of claim 16, wherein the support pin comprises two pin extensions connected by a connection rod.

19. The assembly of claim 18, wherein the connection rod comprises two bends.

20. An apparatus for lifting automobile window glass within a door, the apparatus comprising a lift plate having at least one pin holding well operable to engage a pin extension for immobilization of the lift plate at a mid-travel position.
